(19) United States
(12) Patent Application Publication
(10) Pub. No.: US 2026/0233722 A1
(43) Pub. Date: Aug. 13, 2026

(54) System and Method for Conditionally Releasing a Parking Brake of a Trailer

(71) Applicant: Bendix Commercial Vehicle Systems LLC, Avon, OH (US)

(72) Inventors: Meviltan Y. Mendis, Kenilworth (GB); Amit Patil, North Ridgeville, OH (US); Christopher H. Hutchins, Bay Village, OH (US); Randy J. Salvatora, Columbia Station, OH (US)

(73) Assignee: Bendix Commercial Vehicle Systems LLC, Avon, OH (US)

(21) Appl. No.: 19/049,242

(22) Filed: Feb. 10, 2025

(51) Int. Cl. B60T 13/38; B60T 7/08; B60T 8/17; B60T 8/171; B60T 8/172; B60T 13/68

(52) U.S. Cl. CPC B60T 13/385; B60T 7/08; B60T 8/1701; B60T 8/171; B60T 8/172; B60T 13/683; B60T 2220/04; B60T 2250/00; B60T 2250/04

(57) ABSTRACT

A system and method for conditionally releasing a parking brake of a trailer are provided. In one embodiment, a non-transitory computer-readable storage medium storing a computer program having instructions that, when executed by one or more processors in a vehicle, cause the one or more processors to: determine whether the tractor is stationary; determine whether an engine of the tractor is running; receive a request to release a parking brake of a trailer coupled with the tractor; and cause the parking brake of the trailer to be released in response to determining both that the tractor is stationary and that the engine of the tractor is running. Other embodiments are provided.

### BACKGROUND

A tractor (truck) can be used to tow a trailer. In some vehicles, the trailer is tiltable to dump out its contents. Some countries, such as Australia, have regulations that permit the parking brake of such a trailer to be released only if two conditions are met: (1) the engine is running and (2) the tractor is parked. The first condition ensures that an air compressor in the vehicle is running and can provide the compressed air needed to release the parking brake of the trailer, and the second condition ensures that the tractor will not move when the tipping motion of the trailer causes the trailer to apply a force against the tractor. In addition to these two conditions, the regulations may require the driver to take two independent actions as a safety check before releasing the parking brake of the trailer.

To implement these regulations, a vehicle can be configured with three buttons (see FIG. 5) on the dash of the tractor and a pneumatic circuit (see FIG. 6). One button, which is typically colored yellow, is used to apply or release the parking brake of the tractor when the button is pulled or pushed, respectively. Another button, which is typically colored red, is used to exhaust or supply air to the trailer supply line, which causes the trailer to park and un-park, when that button is pulled or pushed, respectively. A third button, which is typically colored black, is used to allow the driver to provide the two independent actions, where the first action is moving a latch associated with the black button up and the second action is pushing the button.

### BRIEF DESCRIPTION OF THE DRAWINGS

FIG. 1 is a diagram of a braking system of a vehicle of an embodiment.

FIG. 2 is a block diagram of an example implementation of a parking brake controller and parking brake valve module of an embodiment.

FIG. 3 is a flow chart of a method of an embodiment for conditionally releasing a parking brake of a trailer.

FIG. 4 is diagram illustrating processes of an embodiment.

FIG. 5 is a diagram of buttons of a prior art braking system.

FIG. 6 is a pneumatic diagram of a prior art braking system.

### SUMMARY

In one embodiment, a non-transitory computer-readable storage medium storing a computer program having instructions that, when executed by one or more processors in a vehicle, cause the one or more processors to: determine whether the tractor is stationary; determine whether an engine of the tractor is running; receive a request to release a parking brake of a trailer coupled with the tractor; and cause the parking brake of the trailer to be released in response to determining both that the tractor is stationary and that the engine of the tractor is running.

In another embodiment, a method is provided that is performed in a vehicle comprising a tractor and a trailer. The method comprises: determining whether a parking brake of the tractor is engaged; determining whether an air compressor of the tractor is running; receiving a request to disengage a parking brake of the trailer; and causing the parking brake of the trailer to be disengaged in response to determining both that the parking brake of the tractor is engaged and that the air compressor of the tractor is running.

In yet another embodiment, a system is provided comprising: means for determining whether a tractor is parked; means for determining whether an engine of the tractor is running; and means for causing a trailer coupled with the tractor to be un-parked in response to determining both that the tractor is parked and that the engine of the tractor is running.

Other embodiments are possible, and each of the embodiments can be used alone or together in combination.

### DETAILED DESCRIPTION

As mentioned above, in a prior braking system, three buttons and a pneumatic circuit are used to conditionally release a parking brake of a trailer. In the following embodiments, an electronic braking controller is used to conditionally release the parking brake of the trailer without the use of the third button and pneumatic circuit. This can reduce system complexity and cost while maintaining the safety functionality provided by the third button and pneumatic circuit.

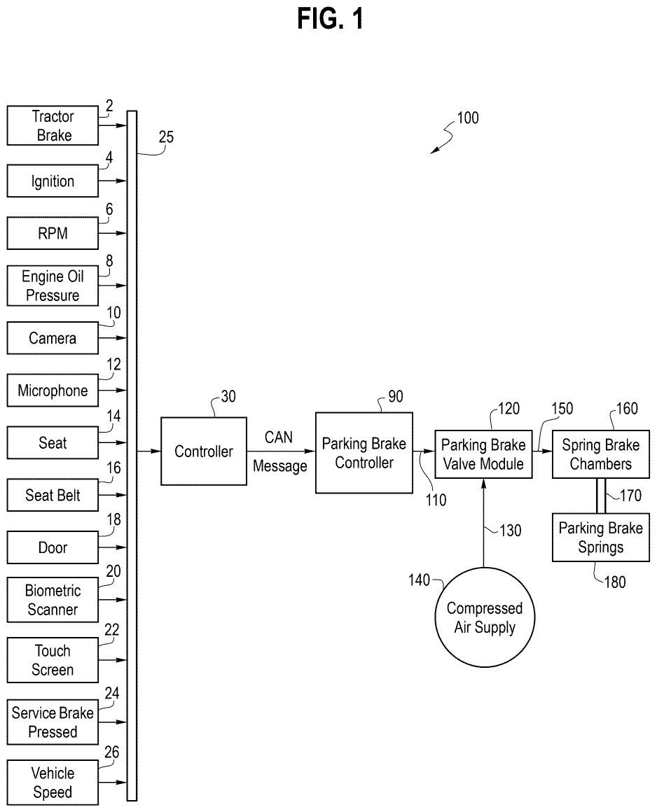

Turning now to the drawings, FIG. 1 is an illustration of a parking brake subsystem 100 of a vehicle of an embodiment. In this example, the vehicle comprises a tractor (truck) that tows a trailer. The trailer can be tilted to dump-out its contents. It should be understood that this is merely an example and that other types of vehicles can be used. Also, in this example, the parking brake subsystem 100 is used to conditionally/selectively release a parking brake of the trailer. This subsystem 100 or a different subsystem can be used for the parking brake of the tractor or other trailers in the vehicle. The vehicle can also have a subsystem for applying service brakes and/or other types of brakes.

As shown in FIG. 1, this subsystem 100 comprises a plurality of sensors/equipment: a tractor brake 2, an ignition 4, an engine revolutions per minute (RPM) sensor 6, an engine oil pressure sensor 8, a camera 10, a microphone 12, a seat sensor 14, a seat belt sensor 16, a door open sensor 18, a biometric sensor 20, a touch screen 22, a module 24 that provides an indication when the service brake is pressed, and a vehicle speed sensor 26. These are merely examples, and other/different types of sensors/equipment can be used. Values from the sensors/equipment are provided (via a bus 25) to a controller 30, which provides the information about these elements to a parking brake controller 90 (e.g., via a controller area network (CAN) message). One or more processors in the parking brake controller 90 can, individually or in combination, analyze this information and selectively provide an electronic control signal (e.g., a voltage) to a parking brake valve module 120, which selectively provides (via hose 130) compressed air from a compressed air supply 140 to spring brake chambers 160 that are coupled with parking brake springs 180 in the trailer.

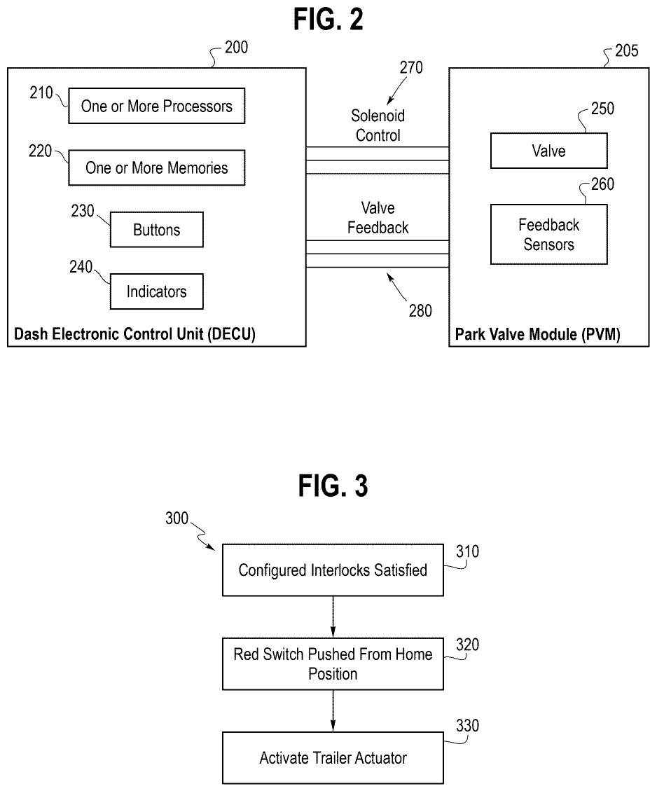

The parking brake controller 90 and the parking brake valve module 120 can take any suitable form. As shown in FIG. 2, in one example implementation, the parking brake controller takes the form of a Dash Electronic Control Unit (DECU) 200 and the parking brake valve module takes the form of a Park Valve Module (PVM) 205, which are both part of the Bendix® Intellipark® Electronic Parking Brake System. It should be noted that this is merely an example and that other implementations can be used. In this example, the DECU 200 comprises at least one processor 210, one or more memories 220, buttons 230 (e.g., the “yellow button” and the “red button” mentioned above), and indicators 240. The PVM 205 comprises a solenoid-controlled valve 250 and feedback sensors 260 (e.g., to provide feedback on whether air is delivered or exhausted). The DECU 200 and PVM 205 communicate via solenoid control lines 270 and valve feedback lines 280. If a vehicle is currently using an Intellipark® Electronic Parking Brake System that is not configured with the functionality described below, a software update (e.g., local or over-the-air) can enable the functionality.

The one or more processors 210 are configured to execute computer-readable program code having instructions (e.g., modules, routines, sub-routine, programs, applications, etc.) that, when executed by the one or more processors 210, cause the one or more processors 210, individually or in combination, to perform certain functions, such as some or all of those discussed herein. The computer-readable program code can be stored in the one or more non-transitory computer-readable memories (storage mediums), such as, but not limited to, volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof. The one or more processors 210 can also take the form of a purely-hardware implementation (e.g., an application-specific integrated circuit (ASIC)).

In this example, the parking brake springs 180 of the trailer have a default state of applying pressure on braking components at the wheel ends of the trailer. To cause the parking brake of the trailer to be released, compressed air needs to flow from the compressed air supply 140 into the spring brake chambers 160 (via lines 130 and 150) to apply pneumatic pressure to the parking brake springs (via line 170) to release them from the braking position. The supply of compressed air from the compressed air supply 140 to the spring brake chambers 160 to release the parking brake is regulated by the parking brake valve module 120, which is controlled by the parking brake controller 90. In this example, the parking brake controller 90 provides a signal (over channel 110) to cause the parking brake valve module 120 to open its valve to cause compressed air to flow to the parking brake springs to release them from the braking position. To re-apply the parking brake in the trailer, the parking brake controller 90 provides signals to the valve in the parking brake valves module 120 so as to exhaust air in one or more chambers of spring brake chambers 180. When air in the spring brake chambers 180 is exhausted and system air pressure drops below a threshold, the parking brake springs 180 are activated to apply the parking brake in the trailer.

A driver can make a request to the parking brake controller 90 to cause the parking brake of the trailer to be released. For example, the driver can push a designated button on the dash (e.g., the “red button” mentioned above). The parking brake controller 90 can be configured to analyze outputs of the sensors/equipment 2-26 to determine whether or not to grant the driver's request. For example, one or more processors in the parking brake controller 90 can, individually or in combination, cause the parking brake of the trailer to be released only if (a) the tractor is parked and (2) the engine of the tractor is running. Using the parking brake controller 90 in this way can eliminate the need for the “black button” and pneumatic circuit described above.

More generally, as shown in the flow chart 300 in FIG. 3, one or more processors in the parking brake controller 90 can, individually or in combination, determine if values from the sensors/equipment 2-26 meet one or more conditions (e.g., if configured interlocks are satisfied) (310). If they do, when the driver requests that the trailer's parking brake be released (e.g., by pushing the “red button”) (320), the one or more processors in the parking brake controller 90 can, individually or in combination, cause the trailer's parking brake to be released (e.g., by activating the trailer actuator) (330).

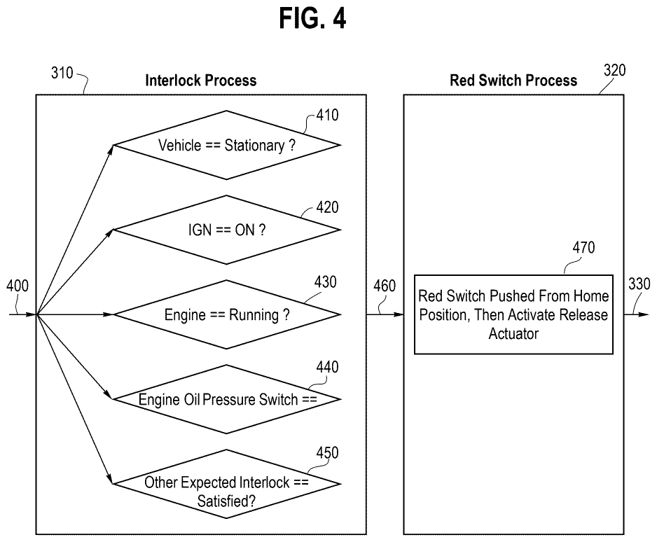

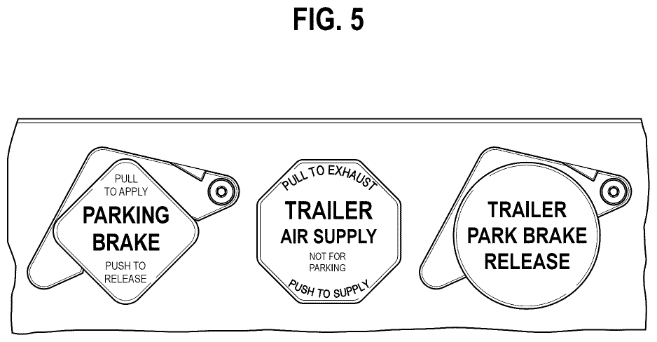

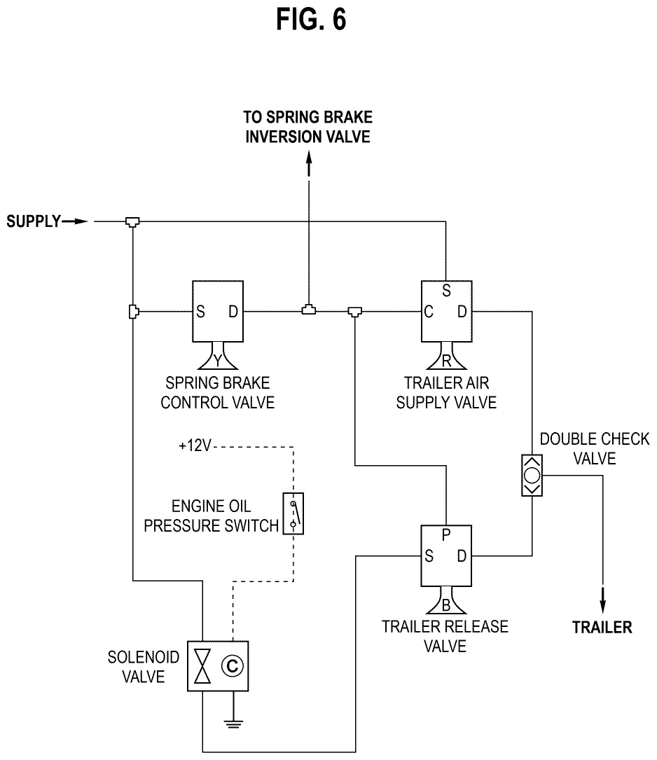

FIG. 4 illustrates these processes in more detail. As shown in FIG. 4, an interlock process 310 executed by the one or more processors in the parking brake controller 90 receive one or more CAN messages 400 from the controller 30 (e.g., using an SAE J1939 communication protocol). This interlock process 310 can determine if one or more conditions are met. For example, the one or more processors in the parking brake controller 90 can, individually or in combination, determine whether the vehicle is stationary (e.g., by determining whether a dashboard tractor parking brake button (here, the “yellow button”) is pushed-in). The vehicle being stationary satisfies one of the two conditions to release the parking brake of the trailer.

The one or more processors in the parking brake controller 90 can, individually or in combination, also determine if the second of the two conditions is satisfied (i.e., that the engine is powering the air compressor to supply compressed air to release the parking brake of the trailer). To do this, the one or more processors in the parking brake controller 90 can, individually or in combination, determine whether the engine's ignition is on (420), whether the engine is running (e.g., whether the revolutions per minute (RPM) of the engine is above a threshold) (430), and whether the engine oil pressure switch is on (e.g., in response to the determining that the engine oil pressure is above a threshold) (440). While a single one of these conditions can be indicative of the engine running, checking more than one (e.g., all) of these conditions can add robustness to the system.

Optionally, the one or more processors in the parking brake controller 90 can, individually or in combination, check if one or more other conditions are satisfied (450). Such other conditions can include, but are not limited to, whether the driver is seated with his seat belt fastened, whether the driver is authorized to use the vehicle, and/or whether the driver is alert enough to operate the vehicle. Other example conditions are described below.

When the interlock process 310 determines that the conditions have been satisfied, an electronic authorization signal 460 is provided to a “red switch” process 320. In that process, when the driver requests that the trailer parking brake be released (e.g., by pushing the “red button”) and the electronic authorization signal 460 has been received, the parking brake controller 90 sends a signal (e.g., provides a voltage) to the parking valve module 120 to cause compressed air to be supplied to release the trailer's parking brake.

Many alternatives can be used with these embodiments. For example, while FIG. 4 shows the testing of conditions before the driver requests release of the trailer's parking brake, in other embodiments, the conditions are tested after the driver requests release of the trailer's parking brake. Also, as mentioned above, different conditions, architectures, and process flows can be used. For example, regulations may require the driver to take two independent actions as a safety check before releasing the parking brake of the trailer. In systems with a third (black) button, those two actions can be satisfied by the driver moving a latch associated with the black button up and then pushing the button. However, in embodiments that do not contain a third button (or even in those that do), the two independent actions can be satisfied in other ways. For example, the two independent actions can be the pushing of the red button and the pressing of the service brake, or they can be the driver simultaneously pulling the yellow button and pushing the red button (in any order) to cause release of the trailer brakes without causing release of the tractor brakes.

In another alternative, one or both of the independent actions can be the driver interacting with a device separate from DECU. The device can be, for example, a switch on the dash or a button displayed on a menu in an instrument cluster or other display inside the vehicle that provides a request to release the trailer brakes. Any other type of device that provides interlocks or security measures can be used, such as, but not limited to, a keypad to enter a password, a camera for facial recognition, and a biometric input device. Also, remote command/enabling and geofencing (e.g., to a predefined area) can be used.

The device user for an interaction can send encrypted messages to the parking brake controller 90, which if valid, can cause the parking brake controller 90 to enable trailer unpark functionality. This can be useful in defending against cyberattacks directed against the instrument cluster (or other component) and can provide an ASIL-D input to the DECU to actually cause the trailer brakes to be released.

In one example implementation, a first step is to arm a special mode via an instrument cluster or other interface, and a second step is to press the red button to cause the trailer brakes to be released independently from the tractor brakes, where an additional action may be required from the driver (e.g., switch action).

It should be noted that while two actions were used in the above examples, more than two actions can be required.

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein. Additionally, “in response to” can be directly in response to or indirectly in response to.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A non-transitory computer-readable storage medium storing a computer program having instructions that, when executed by one or more processors in a tractor, cause the one or more processors, individually or in combination, to:
determine whether the tractor is stationary;
determine whether an engine of the tractor is running;
receive a request to release a parking brake of a trailer coupled with the tractor; and
cause the parking brake of the trailer to be released in response to determining both that the tractor is stationary and that the engine of the tractor is running.

2. The non-transitory computer-readable storage medium of claim 1, wherein determining whether the engine of the tractor is running comprises determining whether an ignition is on.

3. The non-transitory computer-readable storage medium of claim 1, wherein determining whether the engine of the tractor is running comprises determining whether an engine oil pressure switch is on.

4. The non-transitory computer-readable storage medium of claim 1, wherein determining whether the engine of the tractor is running comprises determining whether a revolutions per minute (RPM) of the engine is above a threshold.

5. The non-transitory computer-readable storage medium of claim 1, wherein determining whether the tractor is stationary comprises determining whether a dashboard tractor parking brake button is pushed-in.

6. The non-transitory computer-readable storage medium of claim 1, wherein the request to release the parking brake of the trailer is provided in response to a dashboard trailer parking brake button being pulled-out.

7. The non-transitory computer-readable storage medium of claim 1, wherein the tractor comprises an air compressor that requires the engine of the tractor to be running in order to provide compressed air to cause the parking brake of the trailer to be released.

8. The non-transitory computer-readable storage medium of claim 1, wherein causing the parking brake of the trailer to be released comprises providing a voltage to a park valve to open a valve to allow a flow of compressed air to the parking brake of the trailer, which causes the parking brake of the trailer to be released.

9. The non-transitory computer-readable storage medium of claim 1, wherein the trailer is configured to dump out its contents.

10. The non-transitory computer-readable storage medium of claim 1, wherein the instructions, when executed by the one or more processors in the tractor, further cause the one or more processors, individually or in combination, to:
determine whether at least one other condition is satisfied; and
cause the parking brake of the trailer to be released in response to determining that the tractor is stationary, that the engine of the tractor is running, and that the at least one other condition is satisfied.

11. The non-transitory computer-readable storage medium of claim 10, wherein the request to release the parking brake of the trailer is generated by a driver taking a first action, and wherein the at least one other condition is satisfied in response to the driver taking a second action.

12. The non-transitory computer-readable storage medium of claim 11, wherein the second action comprises the driver pushing a switch to disengage a parking brake of the trailer.

13. The non-transitory computer-readable storage medium of claim 11, wherein the first action comprises pulling a first button and the second action comprise pushing a second button.

14. The non-transitory computer-readable storage medium of claim 11, wherein the second action comprises the driver pressing a displayed user input region on a display device.

15. The non-transitory computer-readable storage medium of claim 1, wherein:
a first button is configured to provide a request to cause a parking brake of a tractor to be released;
a second button is configured to provide the request to release the parking brake of the tractor; and
the parking brake of the trailer is caused to be released without use of a third button.

16. A method comprising:
performing in a vehicle comprising a tractor and a trailer:
determining whether a parking brake of the tractor is engaged;
determining whether an air compressor of the tractor is running;
determining that a service brake was pressed and that a request was received to disengage a parking brake of the trailer; and
causing the parking brake of the trailer to be disengaged in response to determining both that the parking brake of the tractor is engaged and that the air compressor of the tractor is running.

17. The method of claim 16, wherein determining whether the parking brake of the tractor is engaged comprises determining whether a dashboard tractor parking brake button is pushed-in.

18. The method of claim 16, wherein determining whether the air compressor of the tractor is running comprising determining whether the engine is running.

19. The method of claim 18, wherein determining whether the engine is running comprises determining whether an ignition is on, determining whether an engine oil pressure switch is on, and/or determining whether a revolutions per minute (RPM) of the engine is above a threshold.

20. The method of claim 16, wherein the request to disengage the parking brake of the trailer is received in response to a dashboard trailer parking brake button being pulled-in.

21. The method of claim 16, wherein the trailer is configured to dump out its contents.

22. The method of claim 16, wherein the tractor comprises a first user input device configured to request the parking brake of the tractor be disengaged and a second user input device configured to request the parking brake of the trailer be disengaged.

23. The method of claim 22, wherein the tractor lacks a third user input device.

24. A system comprising:
means for determining whether a tractor is parked;
means for determining whether an engine of the tractor is running; and
means for causing a trailer coupled with the tractor to be un-parked in response to determining both that the tractor is parked and that the engine of the tractor is running.
